(19) United States
(12) Patent Application Publication
(10) Pub. No.: US 2018/0087723 A1
(43) Pub. Date: Mar. 29, 2018

(54) LED FIXTURE AND RECEPTACLE

(71) Applicant: AMERLUX LLC, Oakland, NJ (US)

(72) Inventors: Joe Sciancalepore, Oakland, NJ (US); Wojciech Trawinski, Oakland, NJ (US); Itai Leshniak, Fair Lawn, NJ (US)

(21) Appl. No.: 15/715,972

(22) Filed: Sep. 26, 2017

Related U.S. Application Data
(60) Provisional application No. 62/399,956, filed on Sep. 26, 2016.

(51) Int. Cl. F21K 9/23; F21V 23/00; H01R 13/62; F21V 29/77; F21V 3/04

(52) U.S. Cl. CPC F21K 9/23; F21V 23/007; H01R 13/6205; F21Y 2115/10; F21V 29/773; F21V 3/0445; F21V 23/005

(57) ABSTRACT

An LED lighting system includes a receptacle coupled to an electric power source having a surface for receiving a lighting fixture, the surface including a magnet and exposed leads; and an LED fixture which includes an LED lighting element, and a fixture head insertable into the receiving surface of the receptacle, the fixture head including a magnet removably attachable to the magnet of the receptacle, and at least one conductive element which by contact with the exposed leads, allows electrical power to flow from the receptacle to the lighting element.

### BACKGROUND OF THE INVENTION

### 1. Field of the Invention

The subject matter disclosed herein relates generally to lighting devices and more particularly to an LED fixture and receptacle.

### 2. Description of the Related Art

LED lighting units are replacing other types of lighting units for a large number of applications, including office, residential and outdoor lighting. LED lighting fixtures may include more hardware and wiring than traditional fixtures and current installations may not be adapted to receive LED fixtures in an efficient manner.

What is needed is a simple and effective way to secure and provide power to an LED light fixture.

### SUMMARY OF THE INVENTION

An LED lighting system is provided which includes a receptacle coupled to an electric power source having a surface for receiving a lighting fixture, the surface including a magnet and exposed leads; and an LED fixture which includes an LED lighting element, and a fixture head insertable into the receiving surface of the receptacle, the fixture head including a magnet removably attachable to the magnet of the receptacle, and at least one conductive element which by contact with the exposed leads, allows electrical power to flow from the receptacle to the lighting element.

In other embodiments, either the receptacle or the fixture head may include a magnet, while the corresponding element (i.e., the fixture head or receptacle, respectively) may include ferromagnetic material.

### BRIEF DESCRIPTION OF THE DRAWINGS

The features and advantages of the invention are apparent from the following description taken in conjunction with the accompanying drawings in which:

FIG. 1 is a bottom view of an LED lighting fixture receptacle according to the teachings herein;

FIG. 2 is a perspective view of an LED light fixture according to the teachings herein;

FIG. 3 is an enlarged perspective view of the head of the LED light fixture shown in FIG. 2;

FIG. 4 is a schematic perspective view of an axially magnetized ring.

### DETAILED DESCRIPTION OF THE INVENTION

Disclosed herein is an LED lighting fixture (hereinafter referred to as the “LED fixture”) and corresponding LED fixture receptacle (hereinafter referred to as the “receptacle”) to which the LED fixture is secured and connected to an electrical power source. In some embodiments, the LED fixture head includes a magnet which couples to a corresponding magnet or ferromagnetic material on the receptacle, forming a firm and secure connection between the LED fixture and the receptacle. In other embodiments, the LED fixture head instead may include ferromagnetic material which couples to a corresponding magnet on the receptacle. Electrical power is provided to the LED fixture by conductive contact between pins located on the LED fixture head and concentric conductive traces or pads positioned on the receptacle. These elements of the LED fixture and receptacle provide a simple and efficient solution for connecting and disconnecting LED fixtures. Permanent means for attaching the LED fixture to the receptacle are not required, nor are wires required for coupling the LED fixture to the electrical power supply.

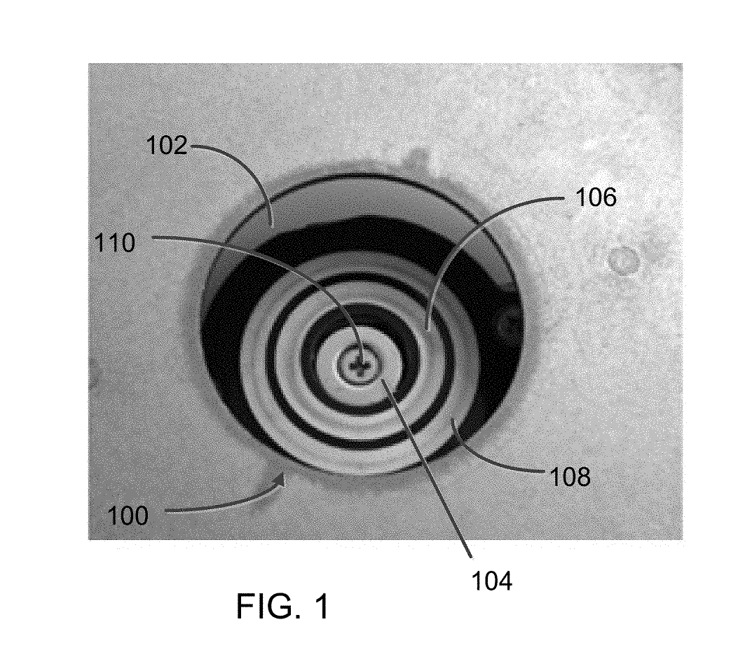

Turning to FIG. 1, a bottom view of an exemplary embodiment of a receptacle 100 for receiving an LED fixture is shown. The receptacle 100 is shown as installed in a recess or hole 102 of a ceiling or wall. The receptacle 100 includes leads or other conductors (not shown in FIG. 1) which couple to an electrical power supply (e.g., building mains, transformer, switch mode power supply or an LED driver) through the recess 102. In the embodiment depicted, the receptacle 100 has a disc-shaped circular profile. On the exposed (bottom) surface of the receptacle 100 may e a number of concentric features including an annular magnet 104, a first annular conductive pad 106, and a second annular conductive pad 108. In some embodiment, the magnet 104 may be also be conductive. Additional pads or annular conductive traces can be used to enable applications in which control wires are used and/or where a number of LEDs are driven, for example, in multi-color LED or multi CCT (color temperature) applications. In the embodiment depicted, the first conductive pad 106 surrounds the centrally positioned magnet 104, and the second conductive pad 108 surrounds the first conductive pad 106. While the receptacle 100, magnet 104, and conductive pads 106, 108 are circular in the depicted embodiment, in alternative embodiments the receptacle, magnet and conductive pads may be formed in other shapes; for example, the magnet and conductive pads may be rectangular. Furthermore, using pads as a form factor is advantageous but not required, and other conductive features such as conductive strips or electrical leads, in general, may suffice. Returning to FIG. 1, the first conductive pad 106 is coupled to internal electrical leads of the receptacle (not shown) and receives thereby a first electrical polarity (i.e., positive or negative voltage in a case of DC supply or phase 1, 2 or 3, etc. in case of AC supply), and the second conductive pad 108 is also coupled to internal electrical leads of the receptacle and receives thereby a second electrical polarity, complementary to the first electrical polarity. In some embodiment, the magnet 104 itself may be coupled to electrical leads of the receptacle.

In the embodiment of FIG. 1, the magnet 104 is also annular in shape and is positioned at the center of the receptacle 100. The magnet 104 may have a relatively high magnetic strength and may be axially polarized (i.e., the magnetic field direction of magnet 104 may be oriented perpendicularly to the annular plane of the magnet). The strength of the magnet 104 is selected so as to provide a firm but still manually detachable bond between the magnet and a corresponding magnet of an LED fixture. The magnet 104 may be secured to other structural elements of the receptacle (not shown) using a threaded member 110 as shown.

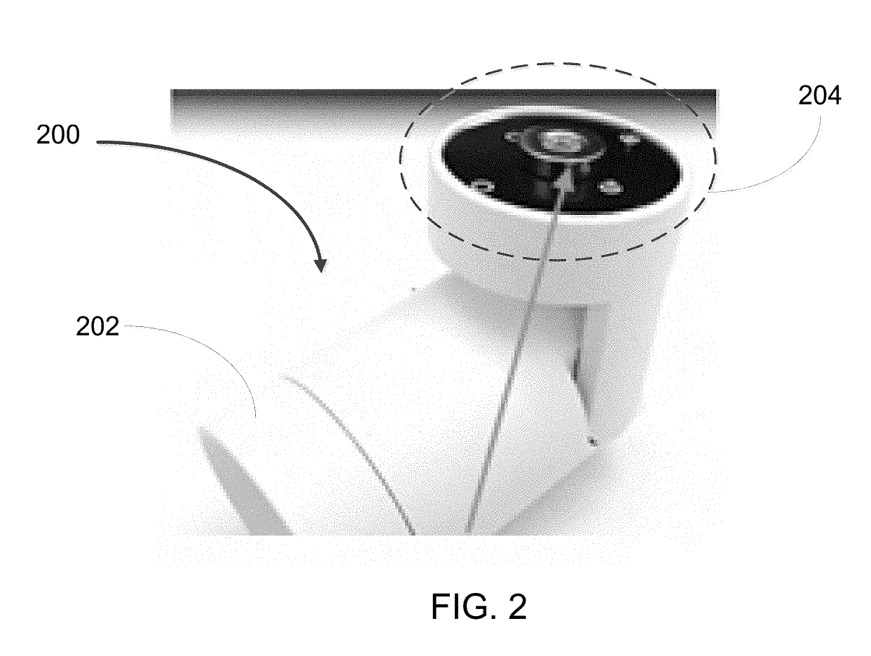

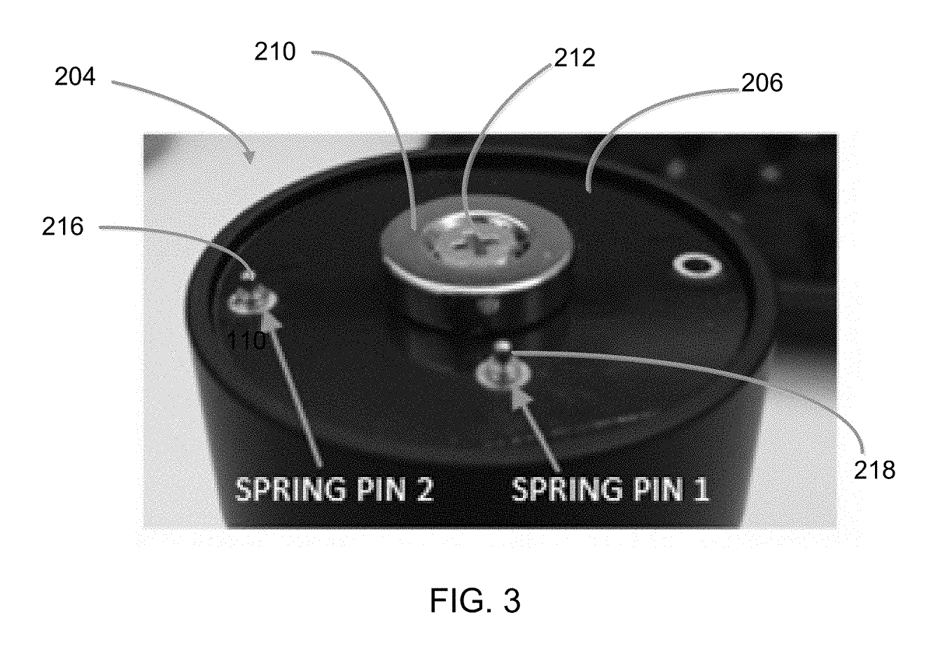

FIG. 2 shows an exemplary LED fixture 200 including a light housing 202 which may include one or more LED lighting elements and a fixture head 204. As shown the light housing 202 may be pivotably coupled to the fixture head 204. FIG. 3 is an enlarged view of the exemplary fixture head 204. The fixture head 204 includes a circular surface 206; an annular axially-polarized magnet 210 is positioned at the center of surface 206, which may be secured to the fixture head 204 by a threaded member 212. Also positioned on the surface 206 is a first spring-biased pin 216 located at a first radial distance from the center of the surface 206, and a second spring-biased pin 218 located at a second radial distance, greater than the first radial distance, from the center of the surface 206.

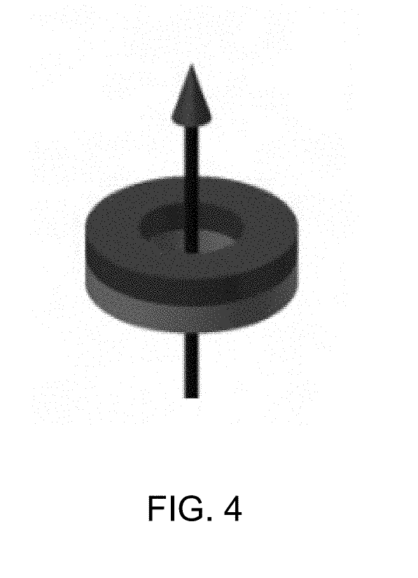

The features on the fixture head 204 are designed to correspond to and couple with features on the receptacle 100. More particularly, magnet 210 is axially polarized so as to be magnetically attracted to magnet 104 on the receptacle. The mutually attractive force between the magnets 104, 210 provides a non-permanent mechanical connection when magnets 104, 210 are brought into close proximity. That is, when magnets 104, 210, which are both of similar axially polarized orientation are placed in close proximity, they align and magnetically join along a commonly shared axis. FIG. 4 schematically illustrates an axially polarized ring magnet including a “north” portion shown in red and a “south” portion shown in white. When the north face of magnet 210 is brought into contact with the south face of magnet 104 (or vice versa, depending on which face is exposed), the north and south faces will join in a tight bond resistant to separation. However, the magnets 104, 210 are manually separable by a user by pulling downwards on the LED fixture 200. To reattach the fixture 200 to the receptacle 100, the user may move LED fixture near the receptacle, through which the mutual attraction of the magnets 104, 210 will align and recouple the LED fixture 200 onto the receptacle 100.

Referring again to FIG. 3, the first spring-biased pin 216 on the fixture head surface 206 is positioned so as to contact first conductive pad 106, and second spring-biased pin 218 is positioned so as contact second conductive pad 108 when the fixture head 204 is attached to the receptacle 100. The pins 216, 218 are conductive and are connected to the lighting elements within the light housing. During installation of the LED fixture 200 onto the receptacle 100, when the pins 216, 218 on the fixture head 204 make a connection with their respective conductive pads 106, 108 on the receptacle 100, a circuit is completed between the conductive pads 106, 108 of opposite polarity through a conductive path provided by the electrically-coupled pins 216, 218 through the lighting elements within the LED fixture. The completed circuit allows electrical power to flow from the receptacle 100 to the lighting elements of the LED fixture 200. The pins 216, 218 advantageously include internal coil springs which are biased so as to force the pins 216, 218 to protrude above the fixture head surface 206 as high as possible. The upward bias of pins 216, 218 ensures a constant contact between the pins 216, 218 and the conductive pads 106, 108 on the receptacle 100.

The arrangement in which conductive pads 106, 108 are implemented as concentric circles of different diameters, enables the ability to rotate the LED fixture 200 in any desired orientation (fully 360 degrees) without affecting the supply of electrical power to the fixture. The probability of a misalignment between the pins 216, 218 and the conductive pads 106, 108 is minimized by the nature of the magnetic connections as well as their concentric location. Magnets 104, 210 with a shared axis of orientation tend to align with each other with a substantial degree of precision and thus the probability of the two magnets 104, 210 being off center relative to each other is low. Similarly, the spring pins 216, 218 are positioned at a specific radial distance from the center of the head surface 2016 on the LED light fixture 200 to match the corresponding radial location of the conductive pads 106, 108 on the receptacle 100. This ensures that the pins 216, 218 are properly aligned with the contact pads 106, 108.

It is again noted that in alternative embodiments, either magnet 104 of the receptacle 100, or magnet 210 of the fixture head 204, may be substituted with ferromagnetic material. That is to say that on either the receptacle 100 or fixture head 204, a pre-magnetized material may be substituted with a magnetizable material to create the bond between the receptacle 100 and fixture head 204.

In addition to the spring pins described above with reference to FIG. 3, other electrical contacts and connectors may be used including spring finger contacts, grounding springs, shield fingers, clips which provide reliability and flexibility.

Having thus introduced aspects of the invention, some additional features, embodiments and considerations are now set forth.

It is noted that the implementation of the LED light fixture and receptacle described with respect to the depicted embodiments represents one of many alternative possible embodiments. For instance, while the annular arrangement of magnets and conductive pads on the receptacle, and corresponding arrangement of magnets and pins on the fixture provides certain advantages in terms of providing for 360 rotation of the LED fixture with respect to the receptacle, where such rotation is not required, the conductive pads may be implemented as arcs, strips or traces that do not form a circle, or any enclosed shape. In general, the conductive pads of the receptacle may be any open circuit path that is may closed by corresponding features on the LED fixture. Additionally, if required for structural stability, multiple magnets may be used, positioned at an offset from the central axis of the LED fixture and receptacle.

A variety of different LED light unit systems, chips, controllers and optics may be used in the LED fixture as deemed appropriate. For example, the lighting units may include LED bulbs, arrays, strips, puck lights, and/or custom LED products. LED chips and controllers may be selected for an appropriate output wattage, illumination intensity, and color variation capability. The optics may include convex and/or concave lenses, reflectors and collimators, among other components.

It should be noted that some of the terminology set forth herein may be in agreement, or only partially an agreement with terminology set forth in the prior related provisional patent application. One skilled in the art will recognize the various uses of terms and be able to make the distinctions. However, if a conflict should exist, terminology is set forth in this disclosure shall prevail. It should be recognized that some adjustment and terminology has been provided to simplify explanation. No conflicts in terminology should be construed or inferred.

Terms of orientation are used herein merely for purposes of convention and referencing, and are not to be construed as limiting. For example, the terms “outward” and “downward” are used in relation to the luminaire. However, it is recognized these terms could be used with reference to a viewer. Accordingly, no limitations are implied or to be inferred.

Standards for performance, materials, assembly or other such parameters are to be judged by a designer, manufacturer, user, owner, operator or other similarly interested party. No particular requirements for any standards are implied or to be inferred by the disclosure here.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The usage of the term “exemplary” is to be construed as meaning one of many possible embodiments. The term “exemplary” is not to be construed as being necessarily indicative of a superior or superlative embodiment, although, in some instances this may be the case.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An LED lighting system comprising:
a receptacle coupled to an electric power source having a surface for receiving a lighting fixture, the surface including at least one of a magnet and ferromagnetic material, and exposed electrical leads; and
an LED fixture including:
an LED lighting element; and
a fixture head insertable into the receiving surface of the receptacle, the fixture head including a magnet removably attachable to the magnet or ferromagnetic material of the receptacle, and at least one conductive element which by contact with the exposed leads allows electrical power to flow from the receptacle to the lighting element.

2. An LED lighting system comprising:
a receptacle coupled to an electric power source having a surface for receiving a lighting fixture, the surface including a magnet and exposed electrical leads; and
an LED fixture including:
an LED lighting element; and
a fixture head insertable into the receiving surface of the receptacle, the fixture head including at least one of a magnet and ferromagnetic material removably attachable to the magnet of the receptacle, and at least one conductive element which by contact with the exposed leads allows electrical power to flow from the receptacle to the lighting element.

3. The LED lighting system of claim 1, wherein the LED fixture may be rotated in any orientation in a plane perpendicular to an axial direction.

4. The LED lighting system of claim 1, wherein the exposed leads on the receptacle include a first annular conductive pad and a second annular conductive pad, concentric with the first annular conductive pad.

5. The LED lighting system of claim 4, wherein the at least one conductive element on the fixture head includes a contact adapted to couple to the first annular conductive pad and a second contact adapted to couple to the second annular conductive pad.

6. The LED lighting system of claim 5, wherein the first and second contacts include pins.

7. The LED lighting system of claim 6, first and second pins are spring biased to protrude from the fixture head.

8. The LED lighting system of claim 5, wherein at least one of the first and second contact includes one of a spring figure contact, shield finger, grounding spring and a clip.
